(19) United States
(12) Patent Application Publication
(10) Pub. No.: US 2024/0380518 A1
(43) Pub. Date: Nov. 14, 2024

(54) WIRELESS LOCAL AREA NETWORK (WLAN) LINK ADAPTATION

(71) Applicant: APPLE INC., Cupertino, CA (US)

(72) Inventors: Wook Bong LEE, San Jose, CA (US); Tianyu WU, Monterey, CA (US); Zhou LAN, San Jose, CA (US); Feng JIANG, Sunnyvale, CA (US); Mohamed ABOUELSEOUD, Burlingame, CA (US); Chitto GHOSH, Fremont, CA (US); Anuj BATRA, Redwood City, CA (US)

(73) Assignee: APPLE INC., Cupertino, CA (US)

(21) Appl. No.: 18/658,805

(22) Filed: May 8, 2024

Related U.S. Application Data
(60) Provisional application No. 63/501,375, filed on May 10, 2023.

(51) Int. Cl. H04L 1/1607; H04W 84/12

(52) U.S. Cl. CPC H04L 1/1621; H04W 84/12

(57) ABSTRACT

Some aspects of this disclosure include an apparatus, method, and computer program product for wireless local area network (WLAN) link adaptation. Some aspects of this disclosure include fast feedback (FB) contents to improve WLAN link adaptation that can address the challenges of ultra-high reliability (UHR) wireless communications. Fast FB contents can include a feedback sequence number (FBSN) that identifies a reference packet and FB data corresponding to the receipt of the reference packet by the receiving device. The FB data can include link adaptation parameters corresponding to the receiving device that the transmitting device can use to adjust (e.g., adapt) subsequent transmissions to the same receiving device. Some aspects include an indicator that informs a receiving device whether to provide a Negative Acknowledgement (NACK) frame (e.g., control packets) with FB contents or not.

### CROSS-REFERENCE TO RELATED APPLICATIONS

The present application claims the benefit of U.S. Provisional Patent Appl. No. 63/501,375, filed May 10, 2023.

### BACKGROUND

### Field

The described aspects relate generally to a wireless local area network (WLAN) link adaptation system.

### Related Art

WLAN link adaptation enables more efficient communication by setting the appropriate transmission parameters for the transmitting device to transmit data to the receiving device, depending on the conditions of the frequency band used for communication.

### SUMMARY

Some aspects of this disclosure include a system, apparatus, article of manufacture, method, and/or computer program product and/or combinations and sub-combinations thereof, for wireless local area network (WLAN) link adaptation.

In some aspects, a receiving device can receive a first physical layer protocol data unit (PPDU) can include a first feedback sequence number (FBSN). The receiving device can transmit a first block acknowledgment (BA) frame including the first FBSN and first feedback (FB) data associated with the reception of the first PPDU. In some aspects, the receiving device can receive a second PPDU including a second FBSN, when the first PPDU and the second PPDU are received from a transmitting device. The receiving device can receive a block acknowledgment request (BAR) frame from the transmitting device. The receiving device can transmit a second BA frame including one of the first FBSN and the first FB data, or the second FBSN and second FB data associated with the most recently successfully received of the first PPDU and the second PPDU.

In some aspects, the receiving device can receive a second PPDU including a second FBSN, in which the first PPDU and the second PPDU are received from a transmitting device. The receiving device can receive a BAR frame from the transmitting device. In response to the BAR frame, the receiving device can transmit a second BA frame including the first FBSN and the first FB data the second FBSN and second FB data.

In some aspects, the receiving device can receive, a second PPDU including a second FBSN, in which the first PPDU and the second PPDU are received from a transmitting device. The receiving device can receive a BAR frame from the transmitting device, in which the BAR frame includes the first FBSN and the second FBSN. The receiving device can transmit a second BA frame including the first FBSN and the first FB data, the second FBSN, and second FB data, in which the second FB data is associated with the reception of the second PPDU. In some aspects, the receiving device can receive a signal frame from the transmitting device instead of a BAR frame, where the signal frame is different than a BAR frame.

In some aspects, the receiving device can receive a second PPDU including a negative acknowledgement (NACK) indicator and a second FBSN. The receiving device can determine that at least one media access control (MAC) protocol data unit (MPDU) of the second PPDU was not successfully received. The receiving device can transmit a NACK frame including the second FBSN and second FB data associated with the second PPDU.

In some aspects, the receiving device can receive a second PPDU including a second FBSN associated with a NACK indicator, where the second FBSN does not equal zero. The receiving device can determine that at least one MAC PPDU of the second PPDU was not successfully decoded. In some aspects, the receiving device can transmit a NACK frame including the second FBSN and second FB data associated with the reception of the second PPDU.

In some aspects, the receiving device can determine Modulation and Coding Scheme (MCS) value based at least on the first PPDU received. The receiving device can include the MCS value in the first FB data. In some aspects, the receiving device can determine a Number of Spatial Streams (NSS) value based at least on the first PPDU received. The receiving device can include the NSS value in the first FB data. In some aspects, the receiving device can determine an interference characteristics based at least on the first PPDU received, in which the first FB data.

In some aspects, the transmitting device can transmit a first PPDU including a FBSN. The transmitting device can receive a first BA frame including the first FBSN and first FB data associated with the first PPDU from a receiving device. The transmitting device can configure, based at least on the first FB data, a transmission parameter for a next PPDU directed to the receiving device.

In some aspects, the transmitting device can transmit a second PPDU to the receiving device. The transmitting device can determine that a second BA frame associated with the second PPDU was not successfully decoded. The transmitting device can transmit a BAR frame associated with the second PPDU. The transmitting device can receive a third BA frame including a second FBSN and a second FB data associated with the second PPDU. The transmitting device can configure, based at least on the second FB data, a transmission parameter for a next PPDU directed to the receiving device.

In some aspects, the transmitting device can transmit a second PPDU to the receiving device. The transmitting device can transmit a request for a BAR frame to the second PPDU. The transmitting device can receive a second BA frame including a second FBSN and a second FB data. The transmitting device can configure, based at least on the second FB data, a transmission parameter for a next PPDU directed to the receiving device.

In some aspects, the transmitting device can transmit a second PPDU including a NACK indicator set to a value, and a second FBSN. The transmitting device can receive a NACK frame including the second FBSN and second FB data associated with the reception of the second PPDU. The transmitting device can configure, based at least on the second FB data, a transmission parameter for a next PPDU directed to the receiving device.

In some aspects, the transmitting device can transmit a second PPDU including a second FBSN associated with a NACK indicator, in which the second FBSN does not equal zero. The transmitting device can receive a NACK frame including the second FBSN and second FB data associated with the reception of the second PPDU. The transmitting device can configure, based at least on the second FB data, a transmission parameter for a next PPDU directed to the receiving device.

### BRIEF DESCRIPTION OF THE FIGURES

The accompanying drawings, which are incorporated herein and form part of the specification, illustrate the presented disclosure and, together with the description, further serve to explain the principles of the disclosure and enable a person of skill in the relevant art(s) to make and use the disclosure.

FIG. 1 illustrates an example system for wireless local area network (WLAN) link adaptation, in accordance with some aspects of the disclosure.

FIG. 2 illustrates a block diagram of an example wireless device for WLAN link adaptation, according to some aspects of the disclosure.

FIG. 3 illustrates an example of WLAN link adaptation flow, according to some aspects of the disclosure.

FIG. 4 illustrates an example of WLAN link adaptation flow for transmitting a block acknowledgment request (BAR) frame to request feedback (FB) data when receiving a block acknowledgment (BA) frame fails or the transmitting device did not receive the BA frame, according to some aspects of the disclosure.

FIG. 5 illustrates an example of WLAN link adaptation flow for transmitting a BAR frame to request FB data when receiving a preamble of a physical layer protocol data unit (PPDU) fails, according to some aspects of the disclosure.

FIG. 6 illustrates an example of variations in transmitting BAR frames, according to some aspects of the disclosure.

FIG. 7 illustrates an example of WLAN link adaptation flow when a preamble of the PPDU includes a NACK indicator, according to some aspects of the disclosure.

FIG. 8 illustrates an example of WLAN link adaptation flow when a feedback sequence number (FBSN) corresponds to the NACK indicator, according to some aspects of the disclosure.

FIG. 9 illustrates an example method for a receiving device in a WLAN link adaptation, according to some aspects of the disclosure.

FIG. 10 illustrates an example method for a transmitting device in a WLAN link adaptation, according to some aspects of the disclosure.

FIG. 11 illustrates an example of computer system for implementing some aspects or portion(s) thereof.

The presented disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects include a system, apparatus, article of manufacture, method, and/or computer program product and/or combinations and sub-combinations thereof for wireless local area network (WLAN) link adaptation. The quality of WLAN communications between a transmitting device and a receiving device depends on the environment of the WLAN communication path between the transmitting device and the receiving device. The technique of configuring the WLAN communication parameters to adapt to the environment of the WLAN communication path to improve the quality of WLAN communication is called WLAN link adaptation.

Transmitting devices typically determine link adaptation parameters (e.g., modulation and coding scheme (MCS) value, number of spatial streams (NSS), resource units (RUs), etc.) But, the link adaptation parameters set by a transmitting device may not be accurate as performance can be highly dependent on the link adaptation algorithm of a receiving device. Further, some wireless communications (e.g., ultra-high reliability (UHR) wireless communications) can include challenges such as: in-device interference in 5 GHz or 6 GHz bands between (e.g., Bluetooth (BT), cellular, Ultra-wideband (UWB)); different interference levels for different subchannels in an aggregated physical layer protocol data unit (PPDU) (A-PPDU) and wide bandwidth operations; and more modes of operation such as joint transmission (JT), coordinated special reuse (CSR), and coordinated beamforming (CBF).

Several methods have been proposed as WLAN link adaptation schemes. In WLAN communications using compressed beamforming, for example, a receiving device reports the communication quality to a transmitting device, but the data overhead is too large for frequent reporting. There are also schemes in which a receiving device reports communication quality using separate packets (e.g., independent of commonly used frames, or included in the commonly used frames), where the contents of the separate packets does not include enough information to address the wireless communications challenges (e.g., in UHR communications) as described above.

Some aspects include fast feedback (FB) contents to improve WLAN link adaptation that can address the challenges of UHR wireless communications. Fast FB contents can include a feedback sequence number (FBSN) that identifies a reference packet and FB data corresponding to the receipt of the reference packet by the receiving device. The FB data can include link adaptation parameters corresponding to the receiving device that the transmitting device can use to adjust (e.g., adapt) subsequent transmissions to the same receiving device. Some aspects include an indicator that informs a receiving device whether to provide a Negative Acknowledgement (NACK) frame (e.g., control packets) with FB contents or not.

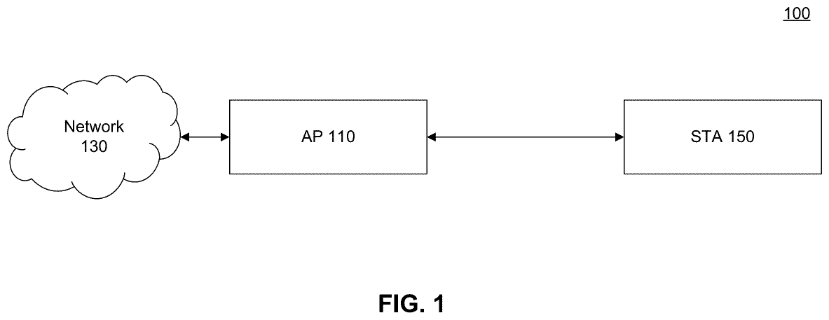

FIG. 1 illustrates an example system 100 for WLAN link adaptation, in accordance with some aspects of the disclosure. Example system 100 is provided for the purpose of illustration only and does not limit the disclosed aspects. System 100 can include, but is not limited to, an access point (AP) station (STA) 110, a non-AP STA 150, and a network 170. The AP STA 110 can include but is not limited to WLAN electronic devices such as a wireless router, a wearable device (e.g., a smart watch), a wireless communication device (e.g., a smart phone), or a combination thereof. The non-AP STA 150 can include, but are not limited to, WLAN STAs such as wireless communication devices, smart phones, laptops, desktops, tablets, personal assistants, monitors, televisions, wearable devices, and the like. The network 130 can be the Internet and/or a WLAN. The communication between the AP STA 110 and the non-AP STA 150 can take place using wireless communications. The wireless communications can be based on a wide variety of wireless communication techniques.

The AP STA 110 and the non-AP STA 150 can transmit and receive data via uplink communications and/or downlink communications. In WLAN communications, the device that transmits a physical layer protocol data unit (PPDU) may be referred to as the transmitting device and the device that receives the PPDU may be referred to as the receiving device. In an uplink communication, the PPDU is transmitted from the non-AP STA 150 to the AP STA 110. Thus, in uplink communications, the non-AP STA 150 is a transmitting device and the AP STA 110 is a receiving device. In contrast, in a downlink communication, the PPDU is transmitted from the AP STA 110 to the non-AP STA 150. Thus, in downlink communications, the AP STA 110 is a transmitting device and the non-AP STA 150 is a receiving device.

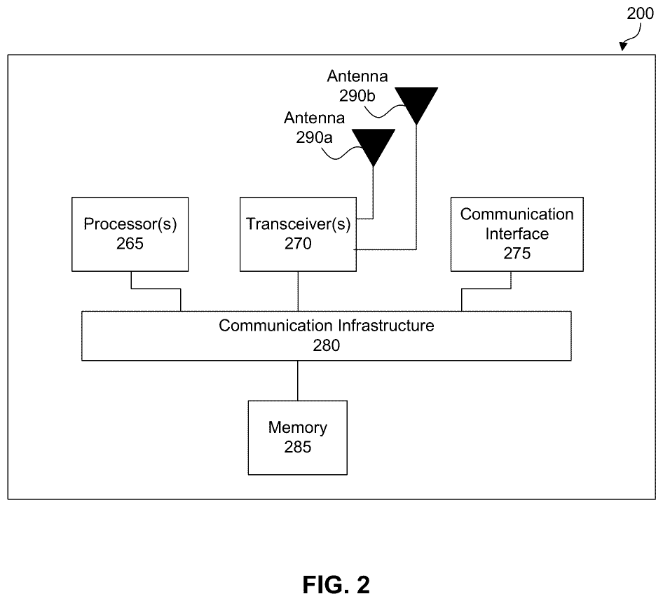

FIG. 2 illustrates a block diagram of an example wireless device 200 for WLAN link adaptation, according to some aspects of the disclosure. For explanation purposes and not a limitation, FIG. 2 can be described with reference to elements from FIG. 1. For example, system 200 can be any of the electronic devices: the AP STA 110, the non-AP STA 150. System 200 includes one or more processors 265, transceiver(s) 270, communication interface 275, communication infrastructure 280, memory 285, and antenna 290. Memory 285 can include random access memory (RAM) and/or cache, and can include control logic (e.g., computer instructions) and/or data. One or more processors 265 can execute the instructions stored in memory 285 to perform operations enabling wireless device 200 to transmit and receive wireless communications, including the functions for WLAN link adaptation. In some aspects, one or more processors 265 can be “hard coded” to perform the functions described herein. Transceiver(s) 270 transmits and receives wireless communications signals including wireless communications supporting WLAN link adaptation according to some aspects, and can be coupled to one or more antennas 290 (e.g., 290a, 290b). In some aspects, a transceiver 270a (not shown) can be coupled to antenna 290a and different transceiver 270b (not shown) can be coupled to antenna 290b. Communication interface 275 allows system 200 to communicate with other devices that can be wired and/or wireless. Communication infrastructure 280 can be a bus. Antenna 290 can include one or more antennas that can be the same or different types.

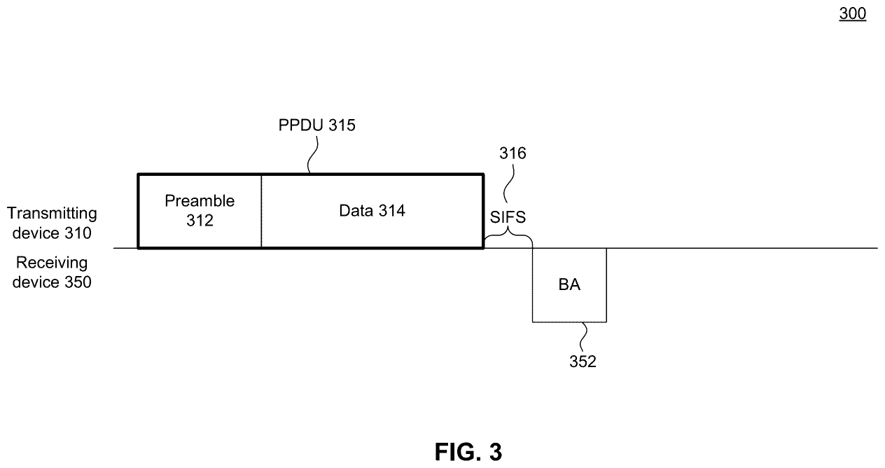

FIG. 3 illustrates an example of WLAN link adaptation flow 300, according to some aspects of the disclosure. For explanation purposes and not a limitation, FIG. 3 can be described with reference to elements from FIG. 1. For example, a transmitting device 310 can be the AP STA 110 or the non-AP STA 150, and a receiving device 350 can be the non-AP STA 150 or the AP STA 110, respectively.

In WLAN link adaptation flow 300, the transmitting device 310 transmits a PPDU 315 with a preamble 312 and data 314 to the receiving device 350. Data 314 can include a user payload and higher layer data units such as Media Access Control (MAC) Protocol Data Units (MPDUs). In some aspects, the PPDU 315 can be a multi-user (MU)-PPDU transmitted for receipt by multiple receiving devices (not shown.)

The receiving device 350 receives and decodes PPDU 315 that includes the preamble 312 and the data 314. If the receiving device 350 successfully decodes the preamble 312 and data 314, the receiving device 350 can transmit a block acknowledge (BA) frame 352 to the transmitting device 310. In some aspects, receiving device 350 transmits BA frame 352 after the elapse of a short inter frame space (SIFS) 316 following the PPDU 315.

The BA frame 352 contains feedback (FB) data that includes link adaptation parameters. The FB data can be used by the transmitting device 310 to configure the transmission parameters for the next PPDU (not shown) sent to the receiving device 350 according to the link adaptation parameters of the FB data. In some aspects, the FB data can contain an MCS value and/or an NSS value corresponding to the receiving device 350. For example, the receiving device 350 can determine the MCS value and/or the NSS value based on a quality of communication of the preamble 312 and/or the PPDU 315 received.

In some aspects, the FB data can include time-domain interference statistics used to determine whether to transmit a Request To Send (RTS) frame or receive a Clear To Send (CTS) frame before the next data transmission (e.g., before transmitting a next PPDU). In some aspects, the FB data can include a PPDU length(s) for the next PPDU(s) to be transmitted. The time-domain interference statistics can include but are not limited to a start time and end time of an interference.

In some aspects, the FB data can include characteristics of interference including but not limited to: the existence of interference, a type of interference, and/or whether the interference is in-channel or in an adjacent channel. In some aspects, the type of interference includes information indicating whether the interference is caused by other WLAN communication signals or other signals (e.g., BT, UWB.) In some aspects, the receiving device 350 can determine the characteristics of an interference based on a quality of communication of the PPDU 315 received.

In some aspects, the transmitting device 310 can configure one or more transmission parameters for the next PPDU directed to the receiving device 350 with the link adaptation parameters based on the FB data received by the transmitting device 310. In some aspects, the transmitting device 310 can set the MCS value of a transmission parameter based on the FB data. In some aspects, the transmitting device 310 can set the NSS value of a transmission parameter based on the FB data. In some aspects, the transmitting device 310 can transmit an RTS frame and receive a CTS frame before transmitting a next PPDU, and/or the transmitting device 310 can set the length of the next PPDU based on the time-domain interference statistics of the FB data.

In some aspects, the preamble 312 can contain a feedback sequence number (FBSN) corresponding to the PPDU 315. The FBSN can be included with the FB data transmitted by the receiving device 350, to indicate that the FB data corresponds to the receipt of PPDU 315. In some aspects, the FBSN can be common for receiving devices allocated in the PPDU 315. For example, the FBSN can be carried in a common field in a physical (PHY)—signal field (SIG). For example, the common field in the PHY-SIG can be a universal-SIG (U-SIG) and/or the common field of a SIG specific to the communication standards to which WLAN communications conform (e.g., an extremely high throughput (EHT)-SIG, and/or an ultra-high reliability (UHR)-SIG. In some aspects, the FBSN can be indicated in a user-specific field in the preamble 312. In some aspects, the FBSN can be included in one or more media access control (MAC) protocol data unit (MPDUs) of the data 314.

In some aspects, the BA frame 352 can contain the BA information, FBSN of the PPDU 315 and the FB data corresponding to the PPDU 315. In some aspects, if the receiving device 350 found a station (STA)-ID of receiving device 350 in a user-specific field of the preamble 312, the receiving device 350 can compute the FB data and send the FB data to a MAC layer of the receiving device 350 together with the FBSN as a receiver (RX)-vector (RXVECTOR). The RXVECTOR is a message from a PHY layer to a MAC layer of the receiving device 350. As such, the receiving device 350 can send the FB data with the FBSN to the transmitting device 310 so that the transmitting device 310 can adjust the MCS value, the NSS value, and/or other link adaptation parameters based on the FB data.

After receiving a FBSN and corresponding FB data, the transmitting device 310 can transmit the next PPDU to the corresponding receiving device (e.g., receiving device 350) using the appropriate link adaptation parameters based on the FB data. In some aspects, since the FB data is transmitted using BA frame 352 corresponding to the reception of the preamble 312 and/or data 314, the transmitting device 310 can quickly (e.g., immediately) set the appropriate link adaptation parameters for the next PPDU transmission and transmit the next PPDU to the receiving device 350. Thus, receiving the FB data is an improvement over past techniques for WLAN link adaptation.

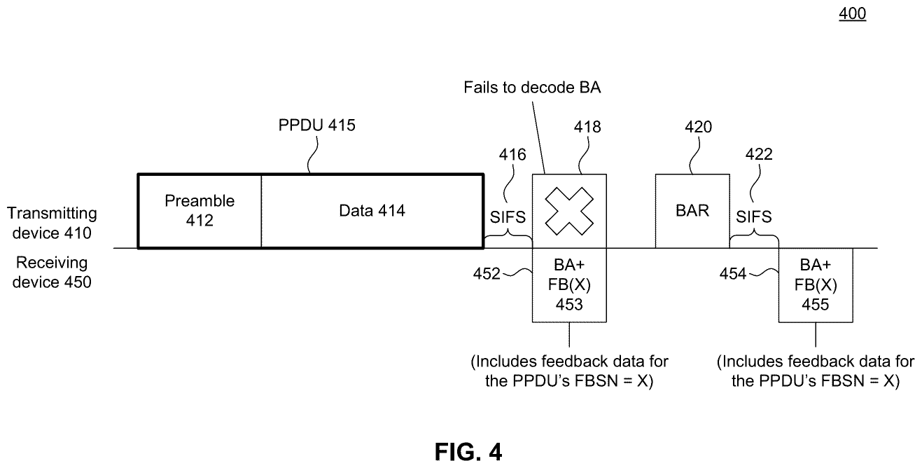

FIG. 4 illustrates an example of WLAN link adaptation flow 400 for transmitting a block acknowledgment request (BAR) frame to request FB data when receiving a BA frame fails or the transmitting device 410 did not receive the BA frame, according to some aspects of the disclosure. For explanation purposes and not a limitation, FIG. 4 can be described with reference to elements from FIG. 1. For example, a transmitting device 410 can be the AP STA 110 or the non-AP STA 150, and a receiving device 450 can be the non-AP STA 150 or the AP STA 110, respectively.

In WLAN link adaptation flow 400, the transmitting device 410 transmits a PPDU 415 with a preamble 412 and data 414 to the receiving device 450. The preamble 412 can include an FBSN, “X” (where the X is an integer), corresponding to the PPDU 415. The properties of the FBSN are described above in the description of FIG. 3 and are not repeated here.

The receiving device 450 receives and decodes the preamble 412 and the data 414. If the receiving device 450 successfully decodes the PPDU 415, the receiving device 450 transmits a BA frame 452. In some aspects, in response to the reception of the PPDU 415, receiving device 450 transmits a BA frame 452 to the transmitting device 410 immediately after a SIFS 416, the period following the PPDU 415. In some aspects, the BA frame 452 can contain BA information and FB (X) 453. The FB (X) 453 can include the FBSN number X, and the FB data corresponding to the receipt of the PPDU 415 associated with the FBSN number X.

In response to the failure to receive or decode the BA frame 452, as shown at operation 418, the transmitting device 410 transmits a block acknowledgment request (BAR) frame 420 to the receiving device 450.

In response to the receipt of the BAR frame 420, the receiving device 450 transmits a BA frame 454 with FB (X) 455. The FB (X) 455 can include the FBSN number X, and the FB data corresponding to the receipt of PPDU 415 associated with the FBSN number X. In some aspects, the receiving device 450 transmits the BA frame 454 with the FB (X) 455 immediately after a SIFS 422, the period following the BAR frame 420. In some aspects, the FB (X) 455 can correspond to the latest FBSN and FB data corresponding to the last PPDU of the PPDUs received by the receiving device 450, from the transmitting device 410 that is successfully received (e.g., decoded.) The transmitting device 410 can configure the transmission parameter for the next PPDU directed to the receiving device 450 based on the FB (X) 455. Thus, the transmitting device 410 can request the FB (X) 455 by using BAR frame 420 even if the BA frame 452 is not received (e.g., due to a failure to receive BA frame 452 or a failed decoding of BA frame 452 at operation 418). In some aspects, configuring the link adaptation parameters for the transmission of the next PPDU in the communication environment that caused the failure to receive BA frame 452, can increase the chances for successful receipt by receiving device 450.

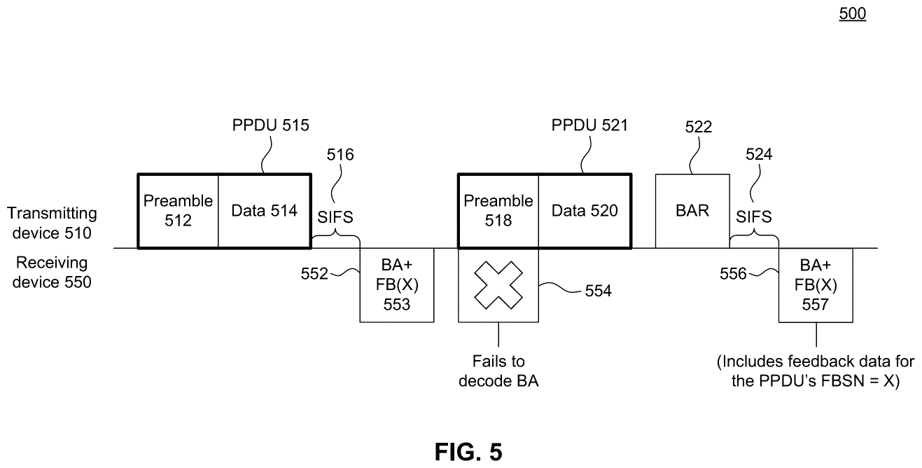

FIG. 5 illustrates an example of WLAN link adaptation flow 500 for transmitting a BAR frame to request FB data when decoding a preamble of a PPDU fails, according to some aspects of the disclosure. For explanation purposes and not a limitation, FIG. 5 can be described with reference to elements from FIG. 1. For example, a transmitting device 510 can be the AP STA 110 or the non-AP STA 150, and a receiving device 550 can be the non-AP STA 150 or the AP STA 110, respectively.

In WLAN link adaptation flow 500, the transmitting device 510 transmits a PPDU 515 with a preamble 512 and data 514 to the receiving device 550. The preamble 512 contains an FBSN, X, corresponding to the PPDU 515. The receiving device 550 receives and decodes the preamble 512 and the data 51. If the receiving device 550 successfully decodes at least one of MPDUs in the PPDU 515, the receiving device 550 transmits a BA frame 552 to the transmitting device 510. In some aspects, receiving device 550 transmits the BA frame 552 immediately after a SIFS 516, the period following the PPDU 515. In some aspects, the BA frame 552 can contain BA information and FB (X) 553 The FB (X) 553 can include the FBSN number X, and the FB data corresponding to the receipt of the PPDU 515 associated with the FBSN number X. In some aspects, the transmitting device 510 can configure the transmission parameter for the next PPDU 521 directed to the receiving device 550 based on the FB (X) 553.

The transmitting device 510 transmits a PPDU 521 with a preamble 518 and data 520 to the receiving device 550. The preamble 518 contains an FBSN, “Y” (where Y is an integer) corresponding to the PPDU 521. The receiving device 550 cannot transmit a BA frame in response to transmitting device 510 because, as shown in operation 554, the receiving device 550 fails to receive (e.g., decode) the preamble 518. The transmitting device 510 transmits a BAR frame 522 to the receiving device 550 in response to not receiving a BA frame corresponding to the PPDU 521 from the receiving device 550. In some aspects, the transmitting device 510 can transmit BAR frame 522 in response to not receiving a BA frame after a predetermined period of time after the PPDU 521 is transmitted.

In response to the receipt of the BAR frame 522, the receiving device 550 transmits a BA frame 556 with an FBSN and FB data corresponding to a last PPDU received from the same transmitting device (e.g., transmitting device 510), namely FB (X) 557. In some aspects, the receiving device 550 transmits the BA frame 556 with the FB (X) 557 after a SIFS 524, the period following the BAR frame 522. Thus, the transmitting device 510 can request the FB (X) 557 using BAR frame 522 when a BA frame is not received (e.g., corresponding FB data is not received because the receiving device 550 failed to decode the preamble 518.)

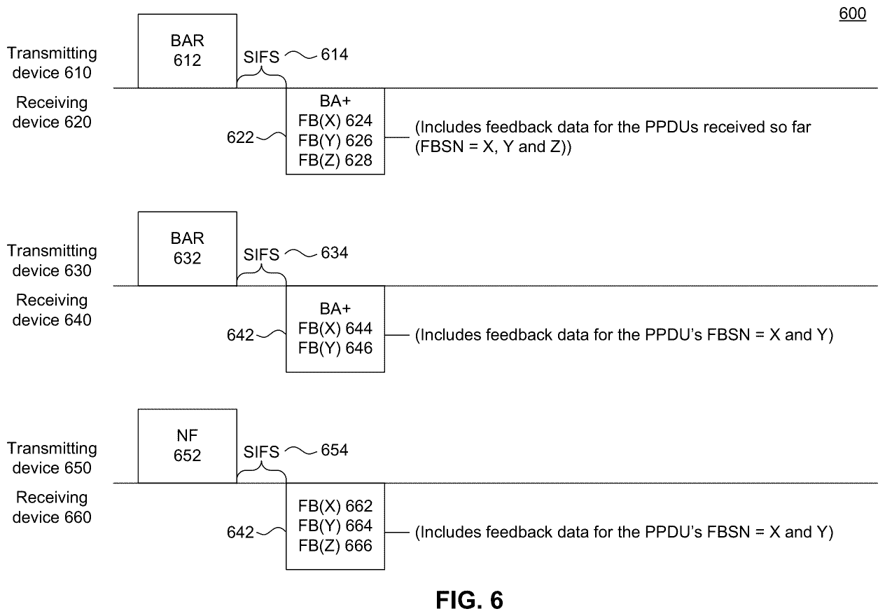

FIG. 6 illustrates an example of variations 600 in transmitting the BAR frames, according to some aspects of the disclosure. For explanation purposes and not a limitation, FIG. 6 can be described with reference to elements from FIG. 1, FIG. 4, and/or FIG. 5. For example, a transmitting device 610, 630, and 650 can be the AP STA 110, the transmitting device 410, or the transmitting device 510. A corresponding receiving device 620, 640, 660 can be the non-AP STA 150, receiving device 450, or the receiving device 550, respectively. Conversely, the transmitting device 610, 630, and 650 can be the non-AP STA 150, receiving device 450, or the receiving device 550. A corresponding receiving device 620, 640, 660 can be the AP STA 110, the transmitting device 410, or the transmitting device 510, respectively.

As explained in FIG. 4 and FIG. 5, in some aspects, in response to the reception of the BAR frames 420 and 522, the receiving device 450 and 550 can transmit the FB (X) 455 and FB (X) 557 corresponding to a last PPDU of the PPDUs from the respective transmitting device that is successfully received (e.g., decoded) received by the receiving device 450 and 550.

In some aspects, a BAR frame 612 from a transmitting device 610 can request FBSN and FB data corresponding to the following: i) PPDUs received from transmitting device 610 in which the PPDUs have different FBSNs; ii) PPDUs received from transmitting device 610 within a predetermined period; and/or iii) PPDUs received from transmitting device 601 for which receiving device 620 has not yet sent FB data. For example, receiving the BAR frame 612 that indicates requests for i, ii, and/or iii, receiving device 620 can transmit BA information and FB (X) 624, FB (Y) 626, and FB (Z) 628 in a BA frame 622 to the transmitting device 610. In some aspects, receiving device 620 can transmit BA frame 622 including the FB (X) 624, FB (Y) 626, and FB (Z) 628 after SIFS 614.

In some aspects, a BAR frame (or multi-user (MU)-BAR frame) 632 from a transmitting device 630 can request FBSN and FB data corresponding to specific FBSNs. For example, the transmitting device 630 can transmit a BAR/MU-BAR frame 632 indicating FBSN(s) (e.g., FBSN X and FBSN Y.) In response to receiving the BAR/MU-BAR frame 632, a receiving device 640 can transmit BA frame 642 that includes BA information and FB (X) 644 and FB (Y) 646, to the transmitting device 630. In some aspects, receiving device 640 can transmit BA frame 642 including the FB (X) 644 and FB (Y) 646 to the transmitting device 630 after SIFS 634.

In some aspects, a transmitting device 650 can request (e.g., poll) FBSN and FB data corresponding to specific FBSNs using a different type of frame that does not correspond to a BA frame or a NACK frame. For example, a transmitting device 650 can transmit a new frame (NF) 652 requesting FB data corresponding to PPDUs associated with FBSN X, FBSN Y, and FBSN Z. In response to the receipt of the NF 652, a receiving device 660 can transmit FB (X) 662, FB (Y) 664, and FB (Z) 666 to the transmitting device 650. In some aspects, receiving device 660 can transmit the FB (X) 662, FB (Y) 664, and FB (Z) 666 to the transmitting device 650 to the transmitting device 650 after SIFS 654. In some aspects, BAR frames, MU-BAR frames, and NFs can be referred to as signal frames.

In some aspects, the BAR frame 420, 522, 612, or 632 can be an MU-BAR transmitted to multiple receiving devices that indicates which FB data the transmitting device requests by indicating specific FBSN(s). In some aspects, a BAR frame or MU-BAR frame can indicate a type of FB data in addition to the corresponding FBSN.

In some aspects, the transmitting device 410, 510, 610, 630, or 650 can transmit multiple BARs or NFs other than the BAR frames 420, 522, 612, 632, and the NF 652. In some aspects, the transmitting device 410, 510, 610, 630, or 650 can transmit additional PPDUs with a different parameter (e.g., transmit the PPDU to a different user group in MU-multiple input multiple output (MIMO) or using a different resource unit (RU.))

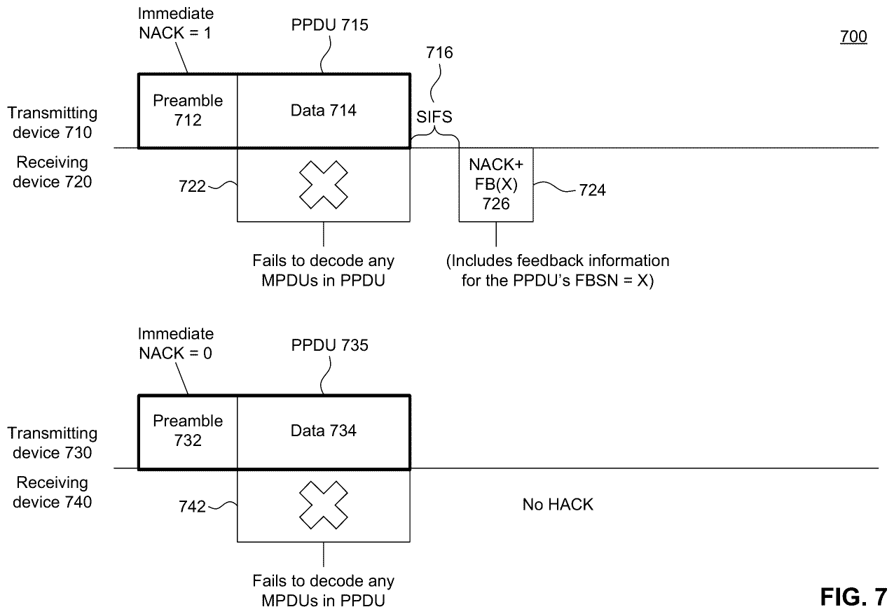

FIG. 7 illustrates an example of WLAN link adaptation flow 700 when a preamble of the PPDU includes a NACK indicator, according to some aspects of the disclosure. For explanation purposes and not a limitation, FIG. 7 can be described with reference to elements from FIG. 1. For example, a transmitting device 710 or 730 can be the AP STA 110 or the non-AP STA 150. A receiving device 720 or 740 can be the non-AP STA 150 or the AP STA 110, respectively.

In WLAN link adaptation flow 700, the transmitting device 710 transmits a PPDU 715 with a preamble 712 and data 714 to the receiving device 720. In some aspects, the PPDU 715 can be a single user (SU)-PPDU. The preamble 712 contains an FBSN which indicates that the FBSN for the PPDU 715 is “X”. In some aspects, the preamble 712 further contains a NACK indicator such as a one bit indicator that informs the receiving device 720 whether there is an immediate BA frame, or a NACK frame (e.g., after a SIFS after the PPDU 715 is received.)

In some aspects, a NACK indicator value can be set (e.g., value=1) in a preamble 712, and the receiving device 720 transmits the NACK frame (e.g., after receiving the PPDU 715 and/or after receiving the PPDU 715 and after the SIFS 716.) For example, receiving device 720 receives the preamble 712 and the data 714, but as shown in operation 722, the receiving device 720 fails to decode at least one of the MPDUs of the data 714. The receiving device 720 transmits a NACK frame 724 and FB (X) 726 after (e.g., immediately after) the elapse of a SIFS 716, the period following the PPDU 715, to the transmitting device 710 in response to the NACK indicator being 1 and the failure to decode an MPDU. The FB (X) 726 corresponds to the FBSN indicated in the preamble 712. Thus, the transmitting device 710 can determine that the receiving device 720 failed to decode any MPDUs of the data 714. Using the link adaptation parameters of FB (X) 726, transmitting device 710 can configure transmission parameters for sending the next PPDU to receiving device 720. In some aspects, the receiving device 720 can transmit the NACK frame 724 without the FB (X) 726.

In some aspects, the receiving device 720 can transmit a BA frame (not shown) with BA information and the FB (X) 726 in response to the NACK indicator being 1 and the MPDUs in the PPDU 715 being correctly received (e.g., decoded.)

In some aspects, the NACK indicator's value may not be set (e.g., value=0) in a preamble 732. In some aspects, transmitting device 730 can transmit a PPDU 735 with a preamble 732 and data 734 to the receiving device 740 in which the preamble 732 contains a NACK indicator with a value of 0. A receiving device 740 receives the preamble 732 and the data 734, but as shown in operation 742, the receiving device 740 fails to receive (e.g., decode) at least one of the MPDUs of the data 734. Consequently, the receiving device 740 may not transmit a NACK frame as shown in FIG. 7.

In some aspects, when the NACK indicator is not set (e.g., value=0) and at least one of the MPDUs is correctly received (e.g., decoded), the receiving device 740 can follow a BA policy corresponding to the correctly received MPDU(s) (not shown.)

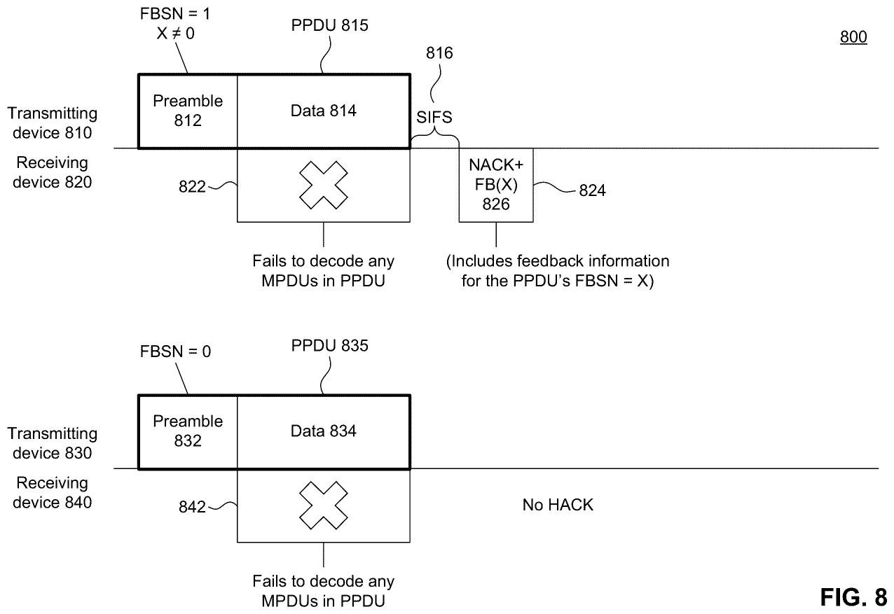

FIG. 8 illustrates an example of WLAN link adaptation flow 800 when a FBSN corresponds to the NACK indicator, according to some aspects of the disclosure. For explanation purposes and not a limitation, FIG. 8 can be described with reference to elements from FIG. 1. For example, a transmitting device 810 or 830 can be the AP STA 110 or the non-AP STA 150, and a receiving device 820 or 840 can be the non-AP STA 150 or the AP STA 110, respectively.

The WLAN link adaptation flow 800, mirrors the WLAN link adaptation flow 700 when the FBSN corresponds to the NACK indicator. For example, FBSN=0 can correspond to the NACK indicator not being set (e.g., value=0.) And, when FBSN does not equal 0 can correspond to the NACK indicator being set (e.g., value=1.)

In some aspects, the transmitting device 810 transmits a PPDU 815 with a preamble 812 and data 814 to the receiving device 820. In some aspects, the PPDU 815 can be an SU-PPDU. The preamble 812 contains an FBSN which indicates that the FBSN for the PPDU 815 is “X” where X is a non-zero value, which is equivalent to a NACK indicator with a set value (e.g., value=1.) The NACK indicator's characteristics are explained in the description of the FIG. 7 and are not repeated here.

A receiving device 820 receives the preamble 812 and the data 814, but as shown in operation 822, fails to decode at least one of the MPDUs of the data 814. The receiving device 820 transmits a NACK frame 824 with FB (X) 826 (e.g., immediately after a SIFS 816, the period following the PPDU 815) to the transmitting device 810. The FB (X) 826 corresponds to the FBSN indicated in the preamble 812. The transmitting device 810 can receive the NACK frame 824 and the FB (X) 826, determine that the receiving device 820 failed to decode any MPDUs in the PPDU 815, and update the transmission parameters for sending the next PPDU to receiving device 820 according to the link adaptation parameters in the FB (X) 826. In some aspects, the receiving device 820 can transmit the NACK frame 824 without the FB (X) 826.

In some aspects, the receiving device 820 can transmit a BA frame with the FB (X) 826 in response to the FBSN X being non-zero (e.g., NACK indicator with set value (e.g., value=1)) and the MPDUs in the PPDU 815 being correctly decoded.

In some aspects, transmitting device 830 can transmit a PPDU 835 with a preamble 832 and data 834 to the receiving device 840 when the preamble 832 contains an FBSN with a value of 0 (which corresponds to NACK indicator not being set (e.g., NACK indicator value=0.) A receiving device 840 receives the preamble 832 and the data 834, but as shown in operation 842, fails to decode at least one of the MPDUs of the data 834. Consequently, receiving device 840 does not transmit a NACK frame as shown in FIG. 8.

In some aspects, when FBSN being equal 0 and at least one of the MPDUs of the data 834 is received correctly (e.g., decoded correctly), the receiving device 840 can follow a BA policy corresponding to the correctly received MPDU(s).

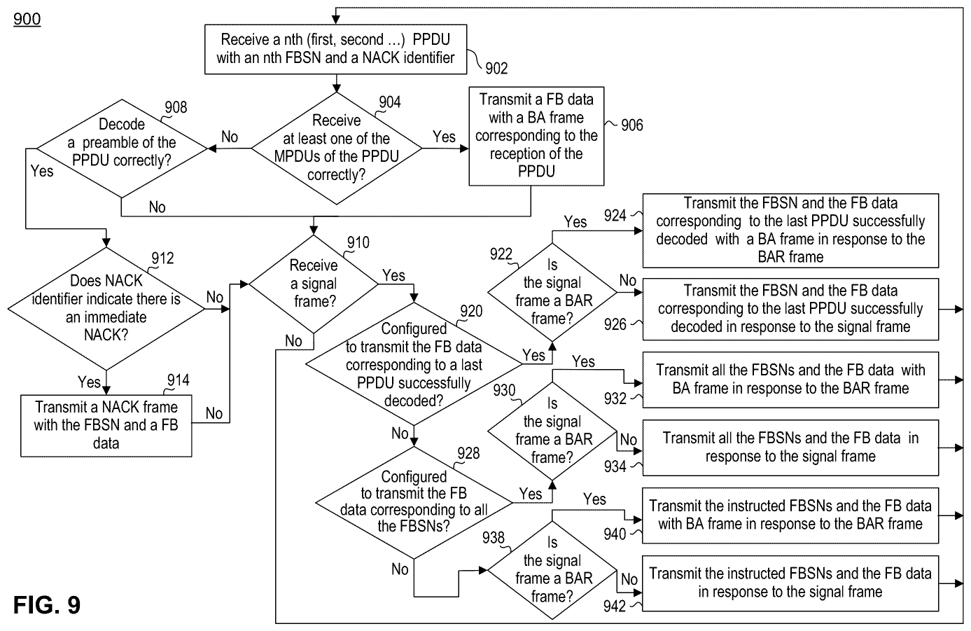

FIG. 9 illustrates an example method 900 for a receiving device in a WLAN link adaptation, according to some aspects of the disclosure. For explanation purposes and not a limitation, method 900 can be described with reference to elements from FIGS. 1-8. For example, method 900 can be performed by system 200 of FIG. 2 or a receiving device including but not limited to the non-AP STA 150, or the receiving devices 350, 450, 550, 620, 640, 660, 720, 740, 820, or 840. The receiving device can communicate with a transmitting device, including but not limited to the AP STA 110, or the transmitting devices 310, 410, 510, 610, 630, 650, 710, 730, 810, or 830.

At operation 902, the receiving device receives a PPDU (e.g., the PPDUs 315, 415, 515, 521, 715, 735, 815, or 835 with corresponding preambles 312, 412, 512, 518, 712, 732, 812, or 832 and data 314, 414, 514, 520, 714, 734, 814, or 834) with an FBSN and/or a NACK indicator. In some aspects, the operation of the receiving device can return to operation 902 multiple times, so the receiving device can receive the first PPDU with the first FBSN, the second PPDU with the second FBSN depending on the number of returns.

At operation 904, the receiving device determines whether the receiving device received (e.g., decoded) at least one of the MPDUs of the PPDU correctly. If the receiving device determines that the receiving device received the PPDU correctly, method 900 proceeds to operation 906. Otherwise, method 900 proceeds to operation 908.

At operation 906, the receiving device transmits the FBSN and corresponding FB data with a BA frame (e.g., the BA frame 352, or 452) corresponding to the reception of the PPDU. The receiving device then proceeds to operation 910. In some aspects, the receiving device can transmit the FBSN and corresponding FB data in the BA frame.

At operation 908, the receiving device determines whether the receiving device received a preamble of the PPDU correctly. If the receiving device determines that the receiving device received the preamble of the PPDU correctly, method 900 proceeds to operation 912. If the receiving device determines that the receiving device did not receive the preamble of the PPDU correctly, method 900 proceeds to operation 910.

At operation 912, the receiving device determines whether the NACK indicator is set (e.g., value=1 or FBSN value is non-zero.) When the NACK indictor is set (e.g., the preambles 712 or 812), method 900 proceeds to operation 914. Otherwise, method 900 proceeds to operation 910.

At operation 914, the receiving device transmits a NACK frame with the FBSN and a FB data (e.g., the NACK frame 724 or 824, and the FB (X) 726 or 826.) In some aspects, the receiving device can transmit the NACK frame 724 without the FB (X) 726 or 826. The receiving device then proceeds to operation 910.

At operation 910, the receiving device determines whether the receiving device receives a signal frame requesting feedback information (e.g., the BAR frame 420, 522, 612, 632, or the NF 652). If the receiving device determines that the receiving device does not receive a signal frame method 900 returns to operation 902.

At operation 920, the receiving device determines whether the receiving device is configured to transmit the FB data corresponding to a last PPDU successfully received (e.g., the BAR frame 420, 522, 612, 632 or NF 652). If the receiving device is configured to transmit the FB data corresponding to a last PPDU successfully received, method 900 proceeds to 922. Otherwise, method 900 proceeds to operation 928.

At operation 922, the receiving device determines the signal frame is a BAR. When the signal frame is a BAR, method 900 proceeds to operation 924. Otherwise, method 900 proceeds to operation 926.

At operation 924, the receiving device transmits the FBSN and a FB data corresponding to the last PPDU successfully decoded (e.g., the FB (X) 455 or 557) within a BA frame (e.g., the BA frame 454 or 556) in response to the BAR frame. The receiving device returns to operation 902.

At operation 926, the signal frame is not a BAR (e.g., the NF 652) and the receiving device transmits the FBSN and a FB data last PPDU successfully decoded in response to the signal frame. The receiving device returns to operation 902.

At operation 928, the receiving device determines whether the receiving device is configured to transmit the FB data corresponding to all the FBSNs received from the same transmitting device. If the receiving device determines the receiving device is configured to transmit the FB data corresponding to all the FBSNs received so far, method 900 proceeds to operation 930. Otherwise, method 900 proceeds to 938.

At operation 930, the receiving device determines whether the signal frame is a BAR. If the receiving device determines that the signal frame is a BAR (e.g., the BAR frame 420, 522, 612, or 632), method 900 proceeds to operation 932.

At operation 932, the receiving device transmits the FBSN, and a FB data corresponding to all the FBSNs received so far (e.g., the FB (X) 624, FB (Y) 626, and FB (Z) 628) within a BA frame (e.g., the BA frame 622) in response to the BAR frame. The receiving device returns to operation 902.

At operation 934, the signal frame is not a BAR (e.g., the NF 652) and the receiving device transmits the FBSN and a FB data corresponding to all the FBSNs received so far in response to the signal frame. The receiving device returns to operation 902.

At operation 938, the receiving device can be configured to transmit the FB data corresponding to FBSNs as instructed in the signal frame. The receiving device determines whether the signal frame is a BAR frame. When the signal frame is a BAR frame, method 900 proceeds to operation 940. Otherwise, method 900 proceeds to operation 942.

At operation 940, the signal frame is a BAR frame (e.g., the BAR frame 420, 522, 612, or 632) and the receiving device transmits the FBSN and a FB data (e.g., the FB (X) 644 and FB (Y) 646) corresponding to FBSNs indicated in the BAR/MU-BAR frame within a BA frame (e.g., the BA frame 642) in response to the BAR frame. The receiving device returns to operation 902.

At operation 942, the signal frame is not a BAR frame (e.g., the signal frame can be the NF 652), and the receiving device transmits the FBSN and a FB data (e.g., the FB (X) 662, FB (Y) 664, and FB (Z) 666) corresponding to the instructions in the signal frame. The method 900 returns to operation 902.

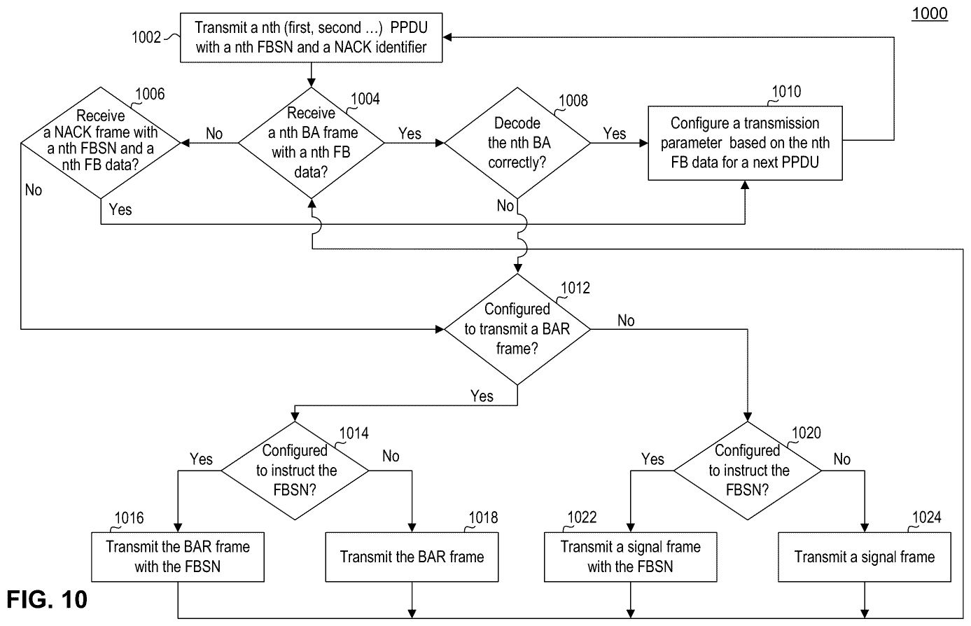

FIG. 10 illustrates an example method 1000 for a transmitting device in a WLAN link adaptation, according to some aspects of the disclosure. For explanation purposes and not a limitation, method 1000 can be described with reference to elements from FIGS. 1-8. For example, method 1000 can be performed by system 200 of FIG. 2, or a transmitting device including but not limited to the AP STA 110, or the transmitting devices 310, 410, 510, 610, 630, 650, 710, 730, 810, or 830. The transmitting device can communicate with a receiving device including but not limited to the non-AP STA 150, or the receiving devices 350, 450, 550, 620, 640, 660, 720, 740, 820, or 840.

At operation 1002, the transmitting device transmits a PPDU (e.g., the PPDUs 315, 415, 515, 521, 715, 735, 815, or 835 with the preambles 312, 412, 512, 518, 712, 732, 812, or 834 and data 314, 414, 514, 520, 714, 734, 814, or 834) with an FBSN and/or a NACK indicator. In some aspects, the operation of the transmitting device can return to operation 1002 multiple times, so the receiving device can transmit the first PPDU with the first FBSN and the second PPDU with the second FBSN, and return to operation 1002.

At operation 1004, the transmitting device determines whether the transmitting device receives a BA frame with a FB data. When the BA frame includes FB data corresponding to the FBSN transmitted at operation 1002, method 1000 proceeds to operation 1008. Otherwise, method 1000 proceeds to operation 1006.

At operation 1006, the transmitting device determines whether the transmitting device receives a NACK frame with the FBSN and the FB data. If the transmitting device determines that the transmitting device receives the NACK frame with the FBSN and the FB data the transmitting device proceeds to operation 1010. If the transmitting device determines that the transmitting device does not receive the NACK frame including the FBSN and the FB data, the method 1000 proceeds to operation 1012.

At operation 1008, the transmitting device determines whether the transmitting device received the BA frame correctly. If the transmitting device determines that the transmitting device received the BA correctly (e.g., the BA frame 454 or 556), method 1000 proceeds to operation 1010. Otherwise, method 1000 proceeds to operation 1012.

At operation 1010, the transmitting device configures a transmission parameter based on the FB data (e.g., link adaptation parameters) received from a receiving device for a next PPDU directed to the receiving device. The transmitting device returns to operation 1002.

At operation 1012, the transmitting device did not decode the BA frame correctly (e.g., the operation 418) or the transmitting device determines that the transmitting device does not receive the NACK frame with the FBSN and the FB data, and the transmitting device determines whether the transmitting device is configured to transmit a BAR frame as a signal frame. If the transmitting device is configured to transmit a BAR frame as a signal frame, transmitting device proceeds to operation 1014. Otherwise, method 1000 proceeds to operation 1020.

At operation 1014, the transmitting device determines whether the transmitting device is configured to instruct the receiving device to provide FB data corresponding to an FBSN. When the transmitting device determines that the transmitting device is configured to instruct the receiving device to provide FB data corresponding to one or more FBSN, method 1000 proceeds to operation 1016. Otherwise, method 1000 proceeds to operation 1018.

At operation 1016, the transmitting device transmits the BAR frame with instructions regarding requesting FB data corresponding to FBSN (e.g., the BAR frame 632), and method 1000 returns to operation 1004.

At operation 1018, the transmitting device transmits the BAR frame (e.g., the BAR frame 420, 522, or 612) without instructions regarding particular FBSNs and corresponding FB data. In some aspects, the configuration regarding providing instructions regarding the FBSN and the FB data can be configured during association. The method 1000 returns to operation 1004.

At operation 1020, the transmitting device determines whether the transmitting device is configured to instruct the receiving device to provide FB data corresponding to an FBSN. When the transmitting device determines that the transmitting device is configured to instruct the receiving device to provide FB data corresponding to one or more FBSN, method 1000 proceeds to operation 1022. Otherwise, method 1000 proceeds to operation 1004.

At operation 1022, the transmitting device transmits a signal frame with instructions regarding requesting FB data corresponding to FBSN (e.g., NF 652), and method 1000 returns to operation 1004.

At operation 1024, the transmitting device transmits the signal frame (e.g., NF 652) without instructions regarding particular FBSNs and corresponding FB data. In some aspects, the configuration regarding providing instructions regarding the FBSN and the FB data can be configured during association. The method 1000 returns to operation 1002.

Various aspects can be implemented, for example, using one or more well-known computer systems, such as computer system 1400 shown in FIG. 14. Computer system 1400 can be any well-known computer capable of performing the functions described herein. For example, and without limitation: the AP STA 110, and the non-AP STA 150 of FIG. 1, the system 200 of FIG. 2, the transmitting devices of FIGS. 3-8 and the receiving devices of FIGS. 3-8 (and/or other apparatuses and/or components shown in the figures) can be implemented using computer system 1400 or portions thereof.

Computer system 1100 includes one or more processors (also called central processing units, or CPUs), such as a processor 1104. Processor 1104 is connected to a communication infrastructure 1106 that can be a bus. One or more processors 1104 can each be a graphics processing unit (GPU). In an embodiment, a GPU is a processor that is a specialized electronic circuit designed to process mathematically intensive applications. The GPU can have a parallel structure that is efficient for parallel processing of large blocks of data, such as mathematically intensive data common to computer graphics applications, images, videos, etc.

Computer system 1100 also includes user input/output device(s) 1103, such as monitors, keyboards, pointing devices, etc., that communicate with communication infrastructure 1106 through user input/output interface(s) 1102. Computer system 1100 also includes a main or primary memory 1108, such as random access memory (RAM). Main memory 1108 can include one or more levels of cache. Main memory 1108 has stored therein control logic (e.g., computer software) and/or data.

Computer system 1100 can also include one or more secondary storage devices or memory 1110. Secondary memory 1110 can include, for example, a hard disk drive 1112 and/or a removable storage device or drive 1114. Removable storage drive 1114 can be a floppy disk drive, a magnetic tape drive, a compact disk drive, an optical storage device, tape backup device, and/or any other storage device/drive.

Removable storage drive 1114 can interact with a removable storage unit 1118. Removable storage unit 1118 includes a computer usable or readable storage device having stored thereon computer software (control logic) and/or data. Removable storage unit 1118 can be a floppy disk, magnetic tape, compact disk, DVD, optical storage disk, and/any other computer data storage device. Removable storage drive 1114 reads from and/or writes to removable storage unit 1118 in a well-known manner.

According to some aspects, secondary memory 1110 can include other means, instrumentalities or other approaches for allowing computer programs and/or other instructions and/or data to be accessed by computer system 1100. Such means, instrumentalities or other approaches can include, for example, a removable storage unit 1122 and an interface 1120. Examples of the removable storage unit 1122 and the interface 1120 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1100 can further include a communication or network interface 1124. Communication interface 1124 enables computer system 1100 to communicate and interact with any combination of remote devices, remote networks, remote entities, etc. (individually and collectively referenced by reference number 1128). For example, communication interface 1124 can allow computer system 1100 to communicate with remote devices 1128 over communications path 1126, which can be wired and/or wireless, and which can include any combination of LANs, WANs, the Internet, etc. Control logic and/or data can be transmitted to and from computer system 1100 via communication path 1126.

The operations in the preceding aspects can be implemented in a wide variety of configurations and architectures. Therefore, some or all of the operations in the preceding aspects can be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 1100, main memory 1108, secondary memory 1110 and removable storage units 1118 and 1122, as well as tangible articles of manufacture embodying any combination of the foregoing. Such control logic, where executed by one or more data processing devices (such as computer system 1100), causes such data processing devices to operate as described herein.

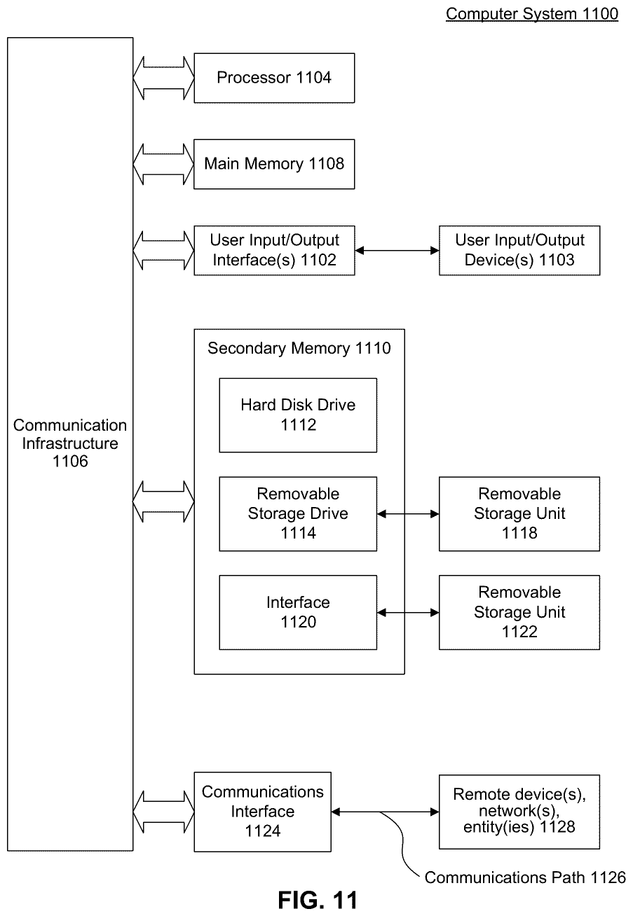

Based on the teachings contained in this disclosure, it will be apparent to persons skilled in the relevant art(s) how to make and use aspects of the disclosure using data processing devices, computer systems and/or computer architectures other than that shown in FIG. 11. In particular, aspects can operate with software, hardware, and/or operating system implementations other than those described herein.

It is to be appreciated that the Detailed Description section, and not the Summary and Abstract sections, is intended to be used to interpret the claims. The Summary and Abstract sections can set forth one or more but not all exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects can perform functional blocks, steps, operations, methods, etc. using orderings different from those described herein.

References herein to “one aspect,” “an aspect,” “an example aspect,” or similar phrases, indicate that the aspect described can include a particular feature, structure, or characteristic, but every aspect can not necessarily include the particular feature, structure, or characteristic. Moreover, such phrases are not necessarily referring to the same aspect. Further, where a particular feature, structure, or characteristic is described in connection with an aspect, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

What is claimed is:

1. A receiving device comprising:
a transceiver; and
a processor communicatively coupled to the transceiver, configured to:
receive, via the transceiver, a first physical layer protocol data unit (PPDU) comprising a first feedback sequence number (FBSN); and
transmit, via the transceiver, a first block acknowledgment (BA) frame comprising the first FBSN and first feedback (FB) data associated with the reception of the first PPDU.

2. The receiving device of claim 1, wherein the processor is further configured to:
receive, via the transceiver, a second PPDU comprising a second FBSN, wherein the first PPDU and the second PPDU are received from a transmitting device;
receive, via the transceiver, a block acknowledgment request (BAR) frame from the transmitting device; and
transmit, via the transceiver, a second BA frame comprising (i) the first FBSN and the first FB data or (ii) the second FBSN and second FB data associated with the more recently successfully received of the first PPDU and the second PPDU.

3. The receiving device of claim 1, wherein the processor is further configured to:
receive, via the transceiver, a second PPDU comprising a second FBSN, wherein the first PPDU and the second PPDU are received from a transmitting device;
receive, via the transceiver, a block acknowledgment request (BAR) frame from the transmitting device; and
transmit, via the transceiver, a second BA frame comprising the first FBSN, the first FB data, the second FBSN, and second FB data.

4. The receiving device of claim 1, wherein the processor is further configured to:
receive, via the transceiver, a second PPDU comprising a second FBSN, wherein the first PPDU and the second PPDU are received from a transmitting device;
receive, via the transceiver, a block acknowledgment request (BAR) frame from the transmitting device, wherein the BAR frame comprises the first FBSN and the second FBSN; and
transmit, via the transceiver, a second BA frame comprising the first FBSN, the first FB data, the second FBSN, and second FB data, wherein the second FB data is associated with reception of the second PPDU.

5. The receiving device of claim 1, wherein the processor is further configured to:
receive, via the transceiver, a second PPDU comprising a second FBSN, wherein the first PPDU and the second PPDU are received from a transmitting device;
receive from the transmitting device, via the transceiver, a signal frame comprising the first FBSN and the second FBSN; and
transmit, via the transceiver, the first FBSN, the first FB data, the second FBSN, and second FB data, wherein the second FB data is associated with reception of the second PPDU.

6. The receiving device of claim 1, wherein the processor is further configured to:
receive, via the transceiver, a second PPDU comprising a negative acknowledgment (NACK) indicator and a second FBSN;
determine that at least one media access control (MAC) protocol data unit (MPDU) of the second PPDU was not successfully received; and
transmit, via the transceiver, a NACK frame comprising the second FBSN and second FB data associated with the reception of the second PPDU.

7. The receiving device of claim 1, wherein the processor is further configured to:
receive, via the transceiver, a second PPDU comprising a second FBSN associated with a negative acknowledgment (NACK) indicator, wherein the second FBSN does not equal zero;
determine that at least one media access control (MAC) protocol data unit (MPDU) of the second PPDU was not successfully decoded; and
transmit, via the transceiver, a NACK frame comprising the second FBSN and second FB data associated with the reception of the second PPDU.

8. The receiving device of claim 1, wherein the processor is further configured to:
determine a Modulation and Coding Scheme (MCS) value based at least on the first PPDU received; and
include the MCS value in the first FB data.

9. The receiving device of claim 1, wherein the processor is further configured to:
determine a Number of Spatial Streams (NSS) value based at least on the first PPDU received; and
include the NSS value in the first FB data.

10. The receiving device of claim 1, wherein the processor is further configured to:
determine an interference characteristic based at least on the first PPDU received; and
include the interference characteristic in the first FB data.

11. A transmitting device comprising:
a transceiver; and
a processor communicatively coupled to the transceiver, configured to:
transmit, via the transceiver, a first physical layer protocol data unit (PPDU) comprising a first feedback sequence number (FBSN);
receive, via the transceiver, a first block acknowledgment (BA) frame comprising the first FBSN and first feedback (FB) data associated with the first PPDU from a receiving device; and
configure, based at least on the first FB data, a transmission parameter for a next PPDU associated with the receiving device.

12. The transmitting device of claim 11, wherein the processor is further configured to:
transmit a second PPDU to the receiving device;
determine that a second BA frame associated with the second PPDU was not successfully decoded;
transmit, via the transceiver, a block acknowledgment request (BAR) frame associated with the second PPDU;
receive, via the transceiver, a third BA frame comprising a second FBSN and a second FB data associated with the second PPDU; and
configure, based at least on the second FB data, a transmission parameter for a next PPDU associated with the receiving device.

13. The transmitting device of claim 11, wherein the processor is further configured to:
transmit a second PPDU to the receiving device;
transmit, via the transceiver, a request for a block acknowledgment request (BAR) to the second PPDU;
receive, via the transceiver, a second BA frame comprising a second FBSN and a second FB data; and
configure, based at least on the second FB data, a transmission parameter for a next PPDU associated with the receiving device.

14. The transmitting device of claim 11, wherein the processor is further configured to:
transmit, via the transceiver, a second PPDU comprising a negative acknowledgment (NACK) indicator set to a value, and a second FBSN;
receive, via the transceiver, a NACK frame comprising the second FBSN and second FB data associated with the reception of the second PPDU; and
configure, based at least on the second FB data, a transmission parameter for a next PPDU associated with the receiving device.

15. The transmitting device of claim 11, wherein the processor is further configured to:
transmit, via the transceiver, a second PPDU comprising a second FBSN associated with a negative acknowledgment (NACK) indicator, wherein the second FBSN does not equal zero;
receive, via the transceiver, a NACK frame comprising the second FBSN and second FB data associated with the reception of the second PPDU; and
configure, based at least on the second FB data, a transmission parameter for a next PPDU directed to the receiving device.

16. A method of operating a receiving device comprising:
receiving, a first physical layer protocol data unit (PPDU) comprising a first feedback sequence number (FBSN); and
transmitting a first block acknowledgment (BA) frame comprising the first FBSN and first feedback (FB) data associated with the reception of the first PPDU.

17. The method of claim 16, further comprising:
receiving a second PPDU comprising a second FBSN, wherein the first PPDU and the second PPDU are received from a transmitting device;
receiving a block acknowledgment request (BAR) frame from the transmitting device; and
transmitting a second BA frame comprising (i) one of the first FBSN and the first FB data or (ii) the second FBSN and second FB data associated with the more recently successfully received of the first PPDU and the second PPDU.

18. The method of claim 16, further comprising:
receiving a second PPDU comprising a second FBSN, wherein the first PPDU and the second PPDU are received from a transmitting device;
receiving from the transmitting device, a signal frame, comprising the first FBSN and the second FBSN; and
transmitting the first FBSN and the first FB data, the second FBSN and second FB data, wherein the second FB data is associated with reception of the second PPDU.

19. The method of claim 16, further comprising:
receiving a second PPDU comprising a negative acknowledgment (NACK) indicator and a second FBSN,
determine that at least one media access control (MAC) protocol data unit (MPDU) of the second PPDU was not successfully received; and
transmitting a NACK frame comprising the second FBSN and second FB data associated with the reception of the second PPDU.

20. The method of claim 16, further comprising:
receiving a second PPDU comprising a second FBSN associated with a negative acknowledgment (NACK) indicator, wherein the second FBSN does not equal zero;
determine that at least one media access control (MAC) protocol data unit (MPDU) of the second PPDU was not successfully decoded; and
transmitting a NACK frame comprising the second FBSN and second FB data associated with the reception of the second PPDU.
